(19) United States
(12) Patent Application Publication
(10) Pub. No.: US 2007/0022120 A1
(43) Pub. Date: Jan. 25, 2007

(54) Caching and modifying portions of a multi-dimensional database on a user device

(75) Inventors: Hai Huang, Redmond, WA (US); Sridharan Venkatramani Ramanathan, Bellevue, WA (US); Xiaohong Mark Yang, Sammamish, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/188,439

(22) Filed: Jul. 25, 2005

(51) Int. Cl. G06F 17/30

(52) U.S. Cl. 707/10

(57) ABSTRACT

For a user of a multi-dimensional database (e.g., as part of an OLAP system), a copy of at least a portion of the multi-dimensional database (i.e., a local cube) may be cached locally on the user's user device. The user then may query the local cube rather than the multi-dimensional database server. Further, the local cube may include not only data from the database but the functions representing the dependencies between pieces of the data. A reporting tool on the user's device may be configured to communicate with the local cube, such that the user may use the reporting tool to experiment with “what if” scenarios in local (e.g., volatile) memory by accessing the data and the functions from the local cube. For example, a thin client side query layer may be provided that directs all queries from a front-end reporting tool to the local cached data.

### BACKGROUND

Multi-dimensional databases (also known as cubes or Unified Dimension Models (UMDs)) have a growing role in today's business world, and are typically the key component for on-line analytical processing (OLAP). Unlike relational databases, which provide only a relatively flat two-dimensional view of data, multi-dimensional databases typically provide many more dimensions of abstraction. Further, multi-dimensional databases typically provide full support for representing hierarchies and combinations of hierarchies. For example, the multi-dimensional view provided by such a database may represent complex combinations of a product line hierarchy, business organization hierarchy, customer hierarchy, time, and other dimensions. Multi-dimensional databases typically are configured with functionality to make complex calculations based on the multiple dimensions of data and the relationships defined between the data. An example of an OLAP system (which by definition employs a multi-dimensional database system) is Microsoft® Analysis Services available from Microsoft Corporation of Redmond, Wash.

Reporting tools that utilize OLAP systems (e.g., Microsoft Analysis Services) typically are configured to generate only static views of the multi-dimensional data. The reporting tool (e.g., an application such as, for example, Microsoft® Excel), which resides on a user device (i.e., client), sends a query over a network to the multi-dimensional database server, and the server generates a view and sends it back to the user device. This view is static in that it does not provide efficient mechanisms to enable users to experiment with the reported view data by interacting with it such as, for example, by performing re-calculation of values when values on which they depend have changed. That is, the user is not allowed to play out “what if” scenarios with the view data. For example, an application may provide a report (i.e., view) in a spreadsheet or table, where the values of one or more cells depend on (i.e., are a function of) the values in one or more other cells.

To experiment with the affects of a change to a piece of data, the user would have to make the change in an application, and transmit it to the server. The server then would perform server-side calculations involving the piece of data, in the multi-dimensional database, and report the change back to the user. The change is permanent in that it is persisted in the database, and thus the change is forced upon other users that share the database. Further, the user has to wait for the communications between the user device and the server, as well as the server calculation time. Also, as the number of users of the OLAP system increases, the number of such communications and calculations involving the server increases, which can cause congestion on the network. This congestion causes further delay, for example, in response to queries.

Another option for implementing “what if” scenarios for multi-dimensional data is to configure the reporting tool itself to perform the necessary calculation between dependent data. However, reporting tools by their nature are rather primitive in their ability to relate the data they present. That is, they typically are only capable of defining and representing relatively flat two-dimensional views of the data. Accordingly, mapping the complex relationships between the data of a multi-dimensional database to the view of the data provided by a reporting tool is typically an extremely arduous, if not impossible, task. Further, reporting tools typically are not configured to perform the often complex multi-dimensional calculations required for changes to data of a multi-dimensional database. In addition, some of these complex calculations involve accessing data not resident on the user device on which the report is being executed (e.g., because the data is not represented in the report). Such data must be retrieved from the server, making it even more difficult and time-consuming to perform multi-dimensional calculations using reporting tools.

Thus, currently available reporting tools are ill-suited for enabling a user to experiment with the affects, on a view of a multi-dimensional database, caused by changing data within the view.

### SUMMARY

This Summary provides an illustrative context for aspects of the invention, in a simplified form. It is not intended to be used to determine the scope of the claimed subject matter, nor to identify key and/or essential features of the claimed subject matter. These and other aspects of the invention are described more fully below in the Detailed Description.

For a user of a multi-dimensional database (e.g., as part of an OLAP system), a copy of at least a portion of the multi-dimensional database (i.e., a local cube) may be cached locally on the user's user device. For example, the user device may send a request to a multi-dimensional database server (e.g., a Microsoft® Analysis Services server) for a local cube for the user. Based on the security context of the user, the cube generated by the server for the user may be a sub-cube; that is, a cube that includes less than all of the multi-dimensional database. The server may store a secure copy of the cube on the server, and transmit the cube to the user device, which may store it locally.

The user then may query the local cube rather than the multi-dimensional database server. Further, the local cube may include not only data from the database but the functions representing the dependency relationships between pieces of the data. A reporting tool on the user's device may be configured to communicate with the local cube. The reporting tool may query the local cube and may perform operations involving data from the local cube and local (e.g., volatile) memory. For example, the operations on the data from a local cube, which may include multi-dimensional operations, may be performed as part of the computer process executing the reporting tool or a computer process spawned therefrom. These operations also may be accessed from the local cube. Thus, a user may work “off-line”, i.e., without a connection to the database server. A user may utilize this capability to experiment with “what if” scenarios locally, without having to access a remote server.

For example, a thin client side query layer may be provided that directs all queries from a front-end reporting tool such as, for example, Microsoft® Excel, to the local cached data. Thus, the front-end reporting tool can fulfill the user needs without connecting to the data server. The user may be enabled to freely change the data presented in a report, and the data change may be sent to the local cube. All related data changes (calculations, aggregations, etc.) then may be calculated relatively quickly as in-memory operations within the client side process, and communicated (e.g., displayed) to the user. For example, a user may make a change to a first cell of a spreadsheet application (e.g., Microsoft® Excel), the resulting database operations may be performed locally, and the affected cells within the spreadsheet may be updated in the user interface display presented to the user.

The multi-dimensional database server that provides the local cube to be a user device may time stamp the local cube. A change list of changes made to the local cube may be maintained on the user device, and each of these changes may be times stamped. Based on the time stamp representing the time that the local cube was loaded from the multi-dimensional database server and/or the time stamps of the changes listed in the change list, the data in the local cube may be synchronized with the data from the multi-dimensional database server from which it was copied. Synchronizational updates may be incremental or may involve a full refresh of the local cube, and may be user-initiated and/or performed at a pre-scheduled time.

In an embodiment of the invention, a system is provided, on a user device of a communications network, for using at least a portion of a multi-dimensional database stored on a network device that is a separate device from the user device on the communications network. The multi-dimensional database is shared by a plurality of user devices on the communications network. The system includes a storage controller to control storing a copy of the at least portion of the multi-dimensional database on a non-volatile storage medium on the user device.

In an aspect of this embodiment, the system also includes a query controller to receive a request from an application executing on the user device for a piece of information included in the at least portion of the multi-dimensional database, and to control retrieving the piece of information from the copy on the non-volatile storage medium.

In another aspect of this embodiment, the at least portion of the multi-dimensional database includes at least a first piece of information that is a function of at least a second piece of information included in the at least portion, and the storage controller is operative to control storing the function within the copy on the non-volatile storage medium. In this aspect, the system further includes a function controller to perform the function on the first piece of information in the volatile memory in response to the application changing a value of the second piece of information in a volatile memory on the user device.

In another aspect of this embodiment, the function controller is operative to communicate a result of the performance of the function to a user interface display of the application, so that a value of the first piece of information resulting from the performance of the function can be displayed.

In another aspect of this embodiment, the change is one of a plurality of changes made in the volatile memory to one or more pieces of information included in the copy of the at least portion of the multi-dimensional database. In this aspect, the system further includes a change list controller to control adding the change to a change list representing the plurality of changes, the change list resident in the volatile memory.

In yet another aspect of this embodiment, the storage controller is operative to control updating the copy of the at least portion of the multi-dimensional database on the non-volatile storage medium by applying the change list from the volatile memory.

In another aspect of this embodiment, the storage controller is operative to control storing the change list on the non-volatile storage medium.

In another aspect of this embodiment, the system further includes a server interface controller to control transmitting the change list from the user device to the network device.

In another aspect of this embodiment, the application is operative to generate a report from the copy of the at least portion of the multi-dimensional database.

In yet another aspect of this embodiment, the system further includes a server interface controller operative to transmit a request to the network device for the copy of the at least a portion of the multi-dimensional database, and to receive the at least portion of the multi-dimensional database.

In another aspect of this embodiment, the system further includes a server interface controller operative to receive at least one communication from the network device indicating one or more changes to the at least portion of the multi-dimensional database. The server interface controller is further operative to control synchronizing the local copy of the at least portion of the multi-dimensional database with the at least portion of the multi-dimensional database in response to the at least one communication.

In another embodiment of the invention, at least a portion of a multi-dimensional database stored on a network device is used by a user device that is a separate device from network device on the communications network. The multi-dimensional database is shared by a plurality of user devices on the communications network. A copy of the at least portion of the multi-dimensional database is stored on the non-volatile storage medium on the user device.

In an aspect of this embodiment, a request is received from an application executing on the user device for a piece of information included in the at least portion of the multi-dimensional database, and the piece of information is retrieved from the copy on the non-volatile storage medium.

In another aspect of this embodiment, the at least portion of the multi-dimensional database includes at least a first piece of information that is a function of at least a second piece of information included in the at least portion. In this aspect, the function is stored within the copy on the non-volatile storage medium, and the function is performed on the first piece of information in the volatile memory in response to the application changing a value of the second piece of information in a volatile memory on the user device.

In another aspect of this embodiment, a result of the performance of the function is displayed to a user of the user device.

In yet another aspect of this embodiment, the change is one of a plurality of changes made in the volatile memory to one or more pieces of information included in the copy of the at least portion of the multi-dimensional database. In this aspect, the change is added to a change list representing the plurality of changes, the change list resident in the volatile memory.

In another aspect of this embodiment, the copy of the at least portion of the multi-dimensional database on the non-volatile storage medium is updated by applying the change list from the volatile memory.

In another aspect of this embodiment, the change list is stored on the non-volatile storage medium.

In another aspect of this embodiment, the change list is transmitted from the user device to the network device.

In yet another aspect of this embodiment, a report is generated from the copy of the at least portion of the multi-dimensional database.

In another aspect of this embodiment, a request is transmitted from the user device to the network device for the copy of at least a portion of the multi-dimensional database, and the copy of the at least portion of the multi-dimensional database is received at the user device.

In another aspect of this embodiment, at least one communication is received from the network device indicating one or more changes to the at least portion of the multi-dimensional database. The local copy of the at least portion of the multi-dimensional database is synchronized with the at least portion of the multi-dimensional database in response to the at least one communication.

In another embodiment of the invention, a computer program product is provided. The product includes a computer-readable medium, and computer-readable signals stored on the computer-readable medium defining instructions that, as a result of being executed by a computer, instruct the computer to perform the method of the embodiment of the invention described in the preceding paragraphs and/or one or more aspects thereof described in the preceding paragraphs.

Other advantages, novel features, and objects of the invention, and aspects and embodiments thereof, will become apparent from the following detailed description of the invention, including aspects and embodiments thereof, when considered in conjunction with the accompanying drawings, which are schematic and which are not intended to be drawn to scale. In the figures, each identical or nearly identical component that is illustrated in various figures is represented by a single numeral. For purposes of clarity, not every component is labeled in every figure, nor is every component of each embodiment or aspect of the invention shown where illustration is not necessary to allow those of ordinary skill in the art to understand the invention.

### BRIEF DESCRIPTION OF THE DRAWINGS

FIG. 1 is a block diagram illustrating an example of a multi-dimensional database system, according to some embodiments of the invention;

FIG. 2 is a block diagram illustrating an example of a system for using, on a user device, a multi-dimensional database stored on a network device that is separate from the user device on a communications network, according to some embodiments of the invention;

FIG. 3 is a flow chart illustrating an example of a method of using, on a user device, at least a portion of a multi-dimensional database stored on a network device remotely disposed from the user device on a communications network, according to some embodiments of the invention;

FIG. 4 is a block diagram illustrating an example of a computer system on which some embodiments of the invention may be implemented; and

FIG. 5 is a block diagram illustrating an example of a storage system that may be used as part of the computer system to implement some embodiments of the invention.

### DETAILED DESCRIPTION

Although some embodiments of the invention are described below primarily in relation to Microsoft® Excel as a reporting tool, it should be appreciated that the invention is not so limited. Any of a variety of other reporting tools may be used. Further, although some embodiments of the invention are described in relation to Microsoft® Analysis Services, other multi-dimensional database systems (i.e., OLAPs) or relational database systems that simulate OLAPs (typically referred to as ROLAPs) may be used and are intended to fall within the scope of the invention.

The function and advantage of these and other embodiments of the present invention will be more fully understood from the examples described below. The following examples are intended to facilitate a better understanding and illustrate the benefits of the present invention, but do not exemplify the full scope of the invention.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Eighth Edition, Revision 2, May 2004), Section 2111.03.

### EXAMPLES

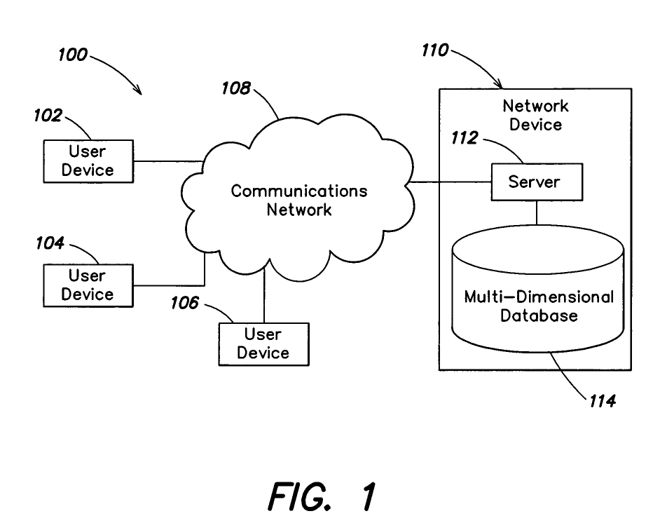

FIG. 1 is a block diagram illustrating an example of a multi-dimensional database system, according to some embodiments of the invention. System 100 is merely an illustrative embodiment of a multi-dimensional database system and is not intended to limit the scope of the invention. Any of numerous other implementations of such a system such as, for example, variations of system 100 are possible and are intended to fall within the scope of the invention.

System 100 may include any of: users devices 102, 104 and 106; communications network 108; server 112; multi-dimensional database 114; other network elements; or any suitable combination of the foregoing.

As used herein, a “network” is a defined group of two or more network elements interconnected by one or more segments of transmission media. One or more of the network elements, which may include network devices, may be configured to transmit and/or receive communications to one or more other network elements over one or more of the segments of transmission media. The network elements that are members of the defined group of the network may change over time, for example, when network elements are added to the network and/or users log on to the network, and when network elements are removed and/or users log off. Each segment may be any of a plurality of types of transmission media, including one or more electrical or optical wires or cables made of metal and/or optical fiber, air (e.g., using wireless transmission over carrier waves) or any combination of these transmission media. As used herein, “plurality” means two or more. It should be appreciated that a network may be as simple as two elements connected by a single wire, bus, wireless connection, or other type of segment(s). Further, it should be appreciated that when a network is illustrated in a drawing of this application as being connected to an element in the drawing, the connected element itself is considered part of the network.

As used herein, a “network device” is a device operative to communicate on a network, including, but not limited to: workstations, personal computers, terminals, laptop computers, end stations, user devices, servers, gateways, registers, switches, routers, hubs, bridges, directories, transmitters, receivers, repeaters, and any combinations thereof. As used herein, a “user device” is a network device from/to which a user may send/receive communications, and which may serve as an endpoint to communications on a communications network. It should be appreciated that a user device may not actually be part of a network at all times. User devices include, but are not limited to: workstations; personal computers (e.g., PCs); laptop computers, notebook computers; telephones (e.g., landline or mobile); pagers; Blackberry™ brand devices, PCS devices, personal digital assistants (PDAs), two-way radios (e.g., “walkie-talkies”), other types of user devices, and any suitable combination of the foregoing.

Network 108 may be and/or include any of a variety of types of networks including, but not limited to, a local area network (LAN), metropolitan area network (MAN), a wide-area network (WAN), a wireless network (e.g., any of those described above), another type of network, or any suitable combination of the foregoing.

As illustrated in FIG. 1, server 112 and multi-dimensional database 114 may reside on a same network device 110. However, it should be appreciated that server 112 and multi-dimensional database 114 may reside on separate devices as well.

Server 112 may control access to multi-dimensional database 114, which may be shared by a plurality of user devices, including user devices 102, 104 and 106. It should be appreciated that even though only three user devices are illustrated in FIG. 1, system 100 may include tens, hundreds or even thousands of user devices. Further, there may be more than one server on network 108. Each user device may access and/or modify data stored in the multi-dimensional database 114 by exchanging communications across the communications network 108 with server 112. For example, a user device may be configured with a query controller (e.g., a client-side query layer) configured to communicate with a query controller (e.g., a server-side query layer) on the server 112 to implement queries. Further, a user device may be configured with other logic to implement changes to the data and communicate these changes to server 112, which can make the changes to the data residing in database 114.

Further, in some embodiments of the invention, server 112 may be configured to generate a cube that is at least a portion of the multi-dimensional database 114, for example, in response to a request received from one of user devices 102, 104 or 106. Server 112 may communicate the cube to the requesting user device. This communication also may include a time stamp representing a time at which the cube was generated. This time stamp may be used by the requesting user device to synchronize the cube with the multi-dimensional database 114, as will be described below in more detail. The server 112 may generate the cube based on a security context of a user or group of users. For example, the server 112 may select only those portions (i.e., slices) of database 114 to which the user has authorization. This selection may involve considering the dependencies between pieces of information. Further, in some embodiments, the request may specify one or more other restrictions on the data to be selected, which the server 112 may take into account when generating the cube.

As will be described below in more detail, a user device (e.g., user device 102, 104 or 106) may be configured to generate a change list representing changes made to one or more pieces of information stored in its local cube, and may be configured to transmit this change list to server 112. Server 112 may be configured to apply the changes in the change list to multi-dimensional database 114 and to report these changes to one or more user devices that share the multi-dimensional database. Further, server 112 may be configured to send periodic updates to the plurality of user devices that share the database, and each update may include a time stamp. These updates may specify changes to multi-dimensional database 114. Further, server 112 may be configured to resolve conflicts between changes made to a same piece of information of multi-dimensional database 114 by two different user devices since one or both of the user devices received a periodic update.

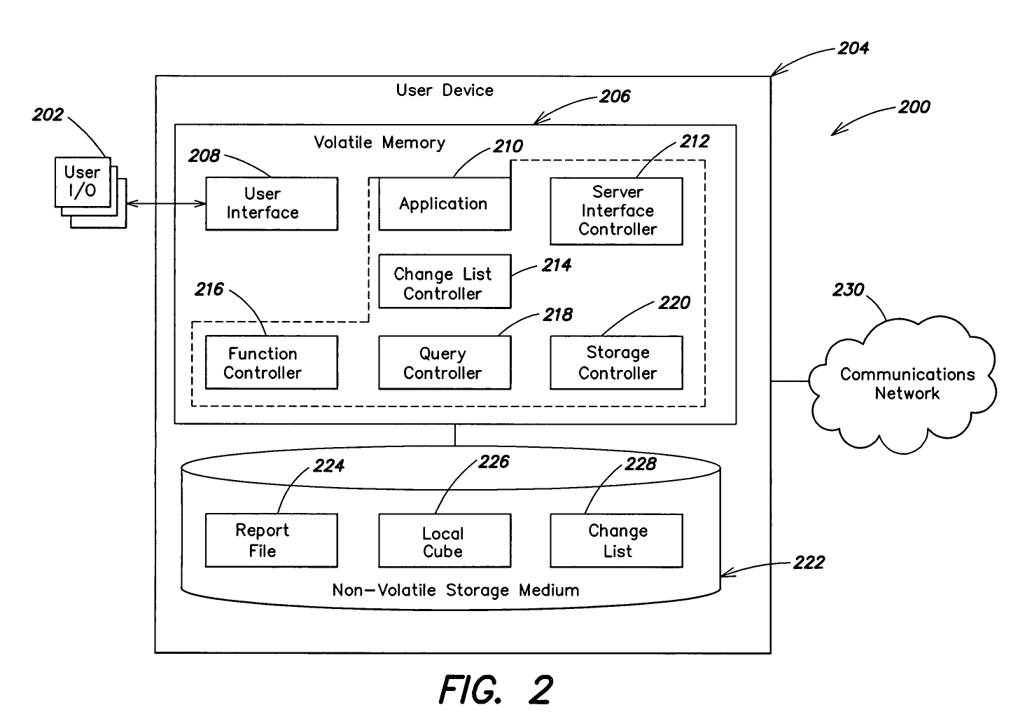

FIG. 2 is a block diagram illustrating an example of a system 200 for using, on a user device, a multi-dimensional database stored on a network device that is separate from the user device on a communications network, according to some embodiments of the invention. System 200 is merely an illustrative embodiment of a system for using, on a user device, a multi-dimensional database stored on a network device that is separate from the user device on a communications network and is not intended to limit the scope of the invention. Any of numerous other implementations of such a system such as, for example, variations of system 200 are possible and are intended to fall within the scope of the invention.

System 200 may include any of: user interface 208; application 210; server interface controller 212; change list controller 214; function controller 216; query controller 218; storage controller 220; non-volatile storage medium 222; communications network 230; other components; and any suitable combination of the foregoing. As illustrated in FIG. 2, in some embodiments, application 210 may be a separate and distinct component from components 212-220. In other embodiments, one or more of these components may be integrated within application 210. For example, one or more of components 212-220, or the functionality that they provide, may be implemented as an add-in to the application 210 (e.g., Microsoft® Excel). Further, one or more of components 208-220 may be stored within a volatile memory 206 during execution of application 210 (i.e., during run time).

Non-volatile storage medium may have stored thereon, at various times, a report file 224, a local cube 226, a change list 228, other components, or any suitable combination of'the foregoing, each of which is described in more detail below.

All of components 206-228 may reside on user device 204 (e.g., any of user devices 102-106 of system 100) as illustrated in FIG. 2, although, in some embodiments, one or more of these components may reside on different devices. For example, non-violate storage medium 222 may reside on a separate device from user device 204. One or more of components 208-220 may be considered part of a “client” of a client/server system, in which the server may be a server of a multi-dimensional database such as, for example, server 112.

Server interface controller 212 may be configured to control transmitting a request to server 112 for at least a portion of multi-dimensional database 114. In response, controller 212 may receive a portion of the multi-dimensional database. Storage controller 220 may be configured to control storing the local cube 226 on a non-volatile storage medium such as, for example, storage medium 222. As used herein, a “local cube” is a copy of at least a portion of a multi-dimensional database stored on (or to be stored on) a non-volatile medium of a user device.

In some embodiments of the invention, local cube 226 may be specific to one or more users of the user device 204. For example, local cube 226 may include only one or more portions of the multi-dimensional database to which the one or more users of user device 204 are allowed access. In such embodiments, the one or more portions to include in the local cube may be determined based on security context(s) of the one or more users in accordance with a security system implemented for the multi-dimensional database system. In such embodiments, care may be taken to ensure that none of the portions of the multi-dimensional database included in the local cube 226 are not authorized for access by the one or more users. As described above, the server 112 may implement these security measures when generating the cube. Limiting the portions as such may involve considering dependency relationships between pieces of data included in the multi-dimensional database.

As described above, caching local cube 226 on user device 204 and allowing users to access and use data and functions stored within the local cube 226 may provide faster access and computational times for users. Further, in cases where the local cube 226 is less than all of the multi-dimensional database, which may be the case for users limited to access to only certain data stored therein, access and processing speeds are further increased due to the reduced amount of data.

The user interface 208 may be configured to receive and output user input and output 202, and serve as the interface between the user and application 210 and/or other components on user device 204. As used herein, a “user interface” is an application or part of an application (i.e., a set of computer-readable instructions) that enables a user to interface with an application during execution of the application. A user interface may include code defining how an application outputs information to a user during execution of the application, for example, visually through a computer screen or other means, audibly through a speaker of other means, and manually through a game controller or other means. Such user interface also may include code defining how a user may input information during execution of the application, for example, audibly using a microphone or manually using a keyboard, mouse, game controller, track ball, touch screen or other means.

The user interface may define how information is visually presented (i.e., displayed) to the user, and defines how the user can navigate the visual presentation (i.e., display) of information and input information in the context of the visual presentation. During execution of the application, the user interface may control the visual presentation of information and enable the user to navigate the visual presentation and enter information in the context of the visual presentation. Types of user interfaces range from command-driven interfaces, where users type commands, menu-driven interfaces, where users select information from menus, and combinations thereof, to GUIs, which typically take more advantage of a computer's graphics capabilities, are more flexible, intuitive and easy to navigate and have a more appealing “look-and-feel” than command-driven and menu-driven visual user interfaces. As used herein, the visual presentation of information presented by a user interface or GUI is referred to as a “user interface display” or a “GUI display,” respectively.

Application 210 may be a reporting tool or other type of application that enables the user to produce reports from data stored within multi-dimensional database 114. In some embodiments of the invention, the application 210 may be configured to interact with (or include) one or more components on user device 204 to access such data from local cube 226, rather than from multi-dimensional database 114. For example, query controller 218 may be configured to receive a request from application 210 for a piece of information included in the local cube 226 (and also within the multi-dimensional database 114 itself), and control retrieving the piece of information from local cube 226 rather than from database 114.

In addition to storing data copied from database 114 and local cube 226, storage controller 220 may be configured to store functions in local cube 226 copied from database 114. These functions may define relationships between pieces of data stored within the local cube, and may include one or more operations, including one or more multi-dimensional operations. For example, a first piece of information may have a value that is a function of at least a second piece of information. In response to a user making a change to the second piece of information in application 210, function controller 216 may perform the function on the first piece of data to modify its value. Function controller 216 may be configured to perform this function in volatile memory 206, thereby providing faster processing times than would otherwise be available if the function were performed remotely on server 112 and/or multi-dimensional database 114. Accordingly, a user may experiment with different values of different pieces of information to determine how these values affect values of other pieces of information in local memory, without having to persist the changes. The results of the performance of such functions may be displayed to a user through user interface 208, for example, in response to a user request to refresh the data presented by the user interface.

For example, a user may change the value appearing in a first cell of a spreadsheet application (e.g., Microsoft® Excel). This value may represent a value of a piece of data from a multi-dimensional database stored in local cube 226. This piece of information may be related to one or more other pieces of information in local cube 226, and each of these relationships may be defined by one or more multi-dimensional operations. In response to the user changing the value in the cell, function controller 216 may be configured to re-calculate the values of all the related pieces of information using the multi-dimensional operations from local cube 226. After the new values have been calculated, function controller 216 may communicate these new values to application 210 and/or user interface 208, such that any cells representing values changed as a result of the re-calculations are updated to reflect the change.

In some embodiments of the invention, changes to pieces of information are recorded in a change list by change list controller 214. Such a change list may be maintained in volatile memory 206, and may be persisted in non-volatile storage medium as change list 228 and/or transmitted to server 112 so that these changes may be recorded in multi-dimensional database 114. For each change in the change list, a time stamp may be recorded along with the change. These time stamps may be used to synchronize local cube 226 with multi-dimensional database 114, as will be described in more detail below.

For example, a user of application 210 can experiment by changing the value of one or more pieces of information to see how this impacts other pieces of information. Each time the user changes a piece of information, the change may be recorded in the change list in volatile memory. After the user has finished experimenting, the user may then change the altered pieces of information back to their original values or leave one or more pieces of information changed. The user then may save the report or other document including the pieces of information as report file 224, and the change list may be applied to local cube 226. Further, the change list itself may be stored in storage medium 222 as change list 228.

Server interface controller 212 may be configured to transmit change list 228 to server 112 so that the changes may be applied to multi-dimensional database 114. For example, server interface controller 212 may be configured to periodically send the change list 228 to server 112 and/or to send the change list in response to an event such as, for example, the saving of the change list 228 to storage medium 222, the closing of application 210, a user command, etc. The change list 228 may be deleted from storage medium 222 after the change list has been transmitted to server 112 to ensure that the same changes are not made again to multi-dimensional database 114, so that the integrity of the data is maintained. Alternatively, other synchronization techniques may be employed that utilize time stamps in the change list, and/or an indication may be maintained in the change list 228 reflecting the last change in the change list sent to server 112.

Server 112 may be configured to coordinate the synchronization of the changes in change list 228 with data in multi-dimensional database 114. For example, server 112 may be configured to synchronize the data in the event that a user has made a change to a piece of information on the user device that has changed since the piece of information was last loaded from database 114 to the user device. Further, server 112 may be configured to push (e.g., periodically) changes made to multi-dimensional database 114 to the plurality of user devices (e.g., user devices 102-106) that share the data in database 114. The user devices then may use the pushed changes to update their local cubes.

Each user device that shares the multi-dimensional database may be configured to employ synchronization techniques itself. For example, server interface controller 212 of user device 204 may be employed to synchronize local cube 226 with multi-dimensional database 114. As described above, the communication from the server to the user device 204 that includes the local cube also may include a time stamp representing the time at which the local cube was generated. Also described above, the server may be configured to transmit periodic updates to the user device that include time stamps. Server interface controller 212 may be configured to synchronize local cube 226 with multi-dimensional database 114 in response to receiving these periodic communications, for example, based on the time stamp communicated with the local cube 226. Controller 212 may be configured to compare the time stamp included with an update from server 112 to the time stamp communicated originally with the local cube 226. If the time stamp of the update is later than that of the local cube, than the local cube is outdated and needs to be synchronized.

Local cube 226 and server interface controller 212 may be configured such that the local cube 226 can be updated incrementally; that is, only pieces of information within local cube 226 that have changed since a last update may be updated. Further, server interface controller 212 may be configured to perform a complete refresh of local cube 226 as well. For example, controller 212 may be configured to request a current local cube from server 112 if it determines that the update received from the server includes changes not included in local cube 226.

Server interface controller 200 may be configured to handle different synchronization scenarios in response to receiving an update from server 112. For example, if no changes have been made to local cube 226 since the last time local cube 226 was incrementally updated or refreshed, then either an incremental update may be made to local cube 226 or a full refresh of the local cube may be performed. If changes have been made to the local cube 226 since the last incremental update or full refresh, controller 212 may be configured to perform a full refresh on local cube 226 and then re-apply such changes. For example, controller 212 may re-apply the changes maintained in change list 228 that occurred between the reception of the update from server 112 and the previous incremental update or refresh.

In some embodiments, when controller 212 is in the process of communicating change list 228 to server 112, controller 212 may “preview the changes.” That is, controller 212 may compare the changes being communicated with changes on multi-dimensional database 114 that have not yet been communicated to user device 204. For example, controller 212 may request an update from server 112 (independent of any periodic updates), and then compare the changes specified in the update to the changes of the change list being communicated. Controller 212 may resolve conflicts between these changes using any of a variety of techniques such as, for example: making incremental changes to local cube 226 based on the changes specified in the update and then applying the changes from the change list; or by executing a full refresh on local cube 226, re-applying the changes of the change list 228 and then transmitting the change list 228 to server 112.

Systems 100 and 200, and components thereof, may be implemented using any of a variety of technologies, including software (e.g., C, C#, C++, Java, or a combination thereof), hardware (e.g., one or more application-specific integrated circuits), firmware (e.g., electrically-programmed memory) or any combination thereof. One or more of the components of systems 100 and/or 200 may reside on a single device (e.g., a computer), or one or more components may reside on separate, discrete devices. Further, each component may be distributed across multiple devices, and one or more of the devices may be interconnected.

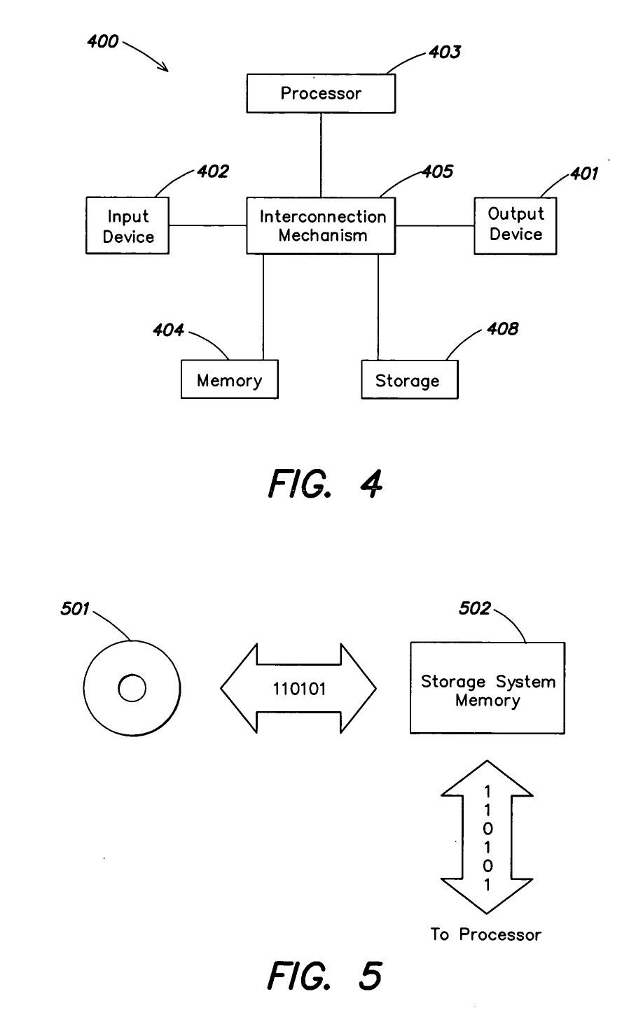

Further, on each of the one or more devices that include one or more components of system 100 and/or 200, each of the components may reside in one or more locations on the system. For example, different portions of the components of these systems may reside in different areas of memory (e.g., RAM, ROM, disk, etc.) on the device. Each of such one or more devices may include, among other components, a plurality of known components such as one or more processors, a memory system, a disk storage system, one or more network interfaces, and one or more busses or other internal communication links interconnecting the various components. System 100 and/or 200, and components thereof, may be implemented using a computer system such as that described below in relation to FIGS. 4 and 5.

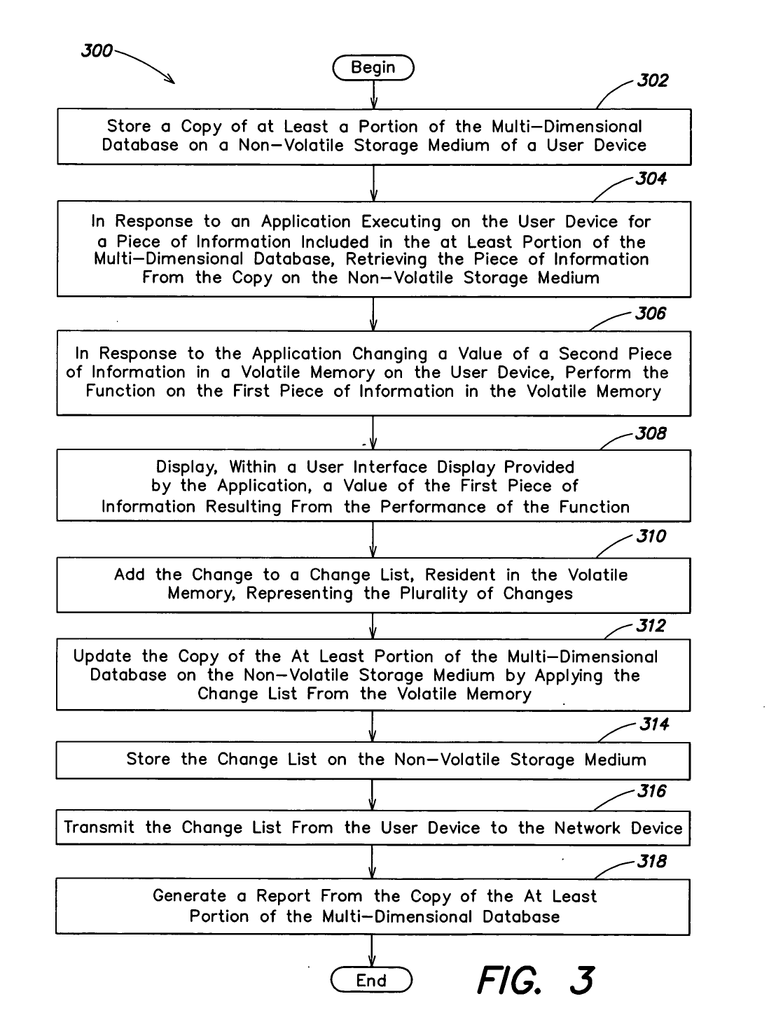

FIG. 3 is a flow chart illustrating an example of a method 300 of using, on a user device, at least a portion of a multi-dimensional database stored on a network device remotely disposed from the user device on a communications network, according to some embodiments of the invention. Method 300 is merely an illustrative embodiment of a method of using, on a user device, at least a portion of a multi-dimensional database stored on a network device remotely disposed from the user device on a communications network, and is not intended to limit the scope of the invention. Any of numerous other implementations of such a method, for example, variations of method 300, are possible and are intended to fall within the scope of the invention.

Initially, a user device may transmit a request for at least a portion of a multi-dimensional database to a server of the multi-dimensional database (not shown), for example, as described above in relation to system 200 of FIG. 1. In response, the server may generate a copy of the at least portion, and transmit the at least portion to the user device (not shown), for example, as described above in relations to system 200.

In Act 302, the copy of the at least a portion of the multi-dimensional database may be stored on a non-volatile storage medium of a user device, for example, as described above, in relation to storage controller 220 of system 200. In Act 304, in response to a request from an application executing on a user device for a piece of information included in the at least portion of the multi-dimensional database (i.e., the local cube), the piece of information may be retrieved from the local cube. Act 304 may be performed as described above in relation to system 200.

As described above, in some embodiments, at least one or more first pieces of information may be a function of (i.e., depend on) a value of a second piece of information of a local cube. Accordingly, in Act 306, in response to the application changing a value of the second piece of information in a volatile memory on the user device, the function (e.g., one or more operations) may be performed on the first piece of information in the volatile memory. Act 306 may be performed by function controller 216 of system 200 as described above in relation to FIG. 2.

In Act 308, the value of the first piece of information resulting from the performance of the function may be displayed within a user interface display provided by the application, for example, as described above in relation to system 200. In Act 310, the change may be added to a change list representing the plurality of changes. For example, the change list may be resident in volatile memory. Act 310 may be performed by change list controller 214 of system 200 as described above in relation to FIG. 2.

In Act 312, a copy of the local cube may be updated by applying the change list from the volatile memory to the local cube, for example, as described above in relation to method 200.

In Act 314, the change list may be stored on the non-volatile storage medium, for example, as described above in relation to change list controller 214 of method 200. In Act 316, the change list may be transmitted from a user device to the network device, for example, as described above in relation to server interface controller 212 of system 200.

Although not shown in FIG. 3, method 300 may include receiving periodic communications from a multi-dimensional database server that may specify updates to the multi-dimensional database. Any of a variety of synchronization techniques such as, for example, any of those described above in relation to system 200, may be applied to the local cube and/or the multi-dimensional database in response to receiving such an update.

In Act 318, a report may be generated from the local cube, for example, as described above in relation to 200.

One or more acts of method 300 may be performed in parallel (at least partially) or in orders other than those illustrated in FIG. 3. For example, Act 318 of generating a report may be performed any time during the performance of method 300. Further, Act 316 of transmitting the change list from the user device to the network device may be performed before either of Act 312 and 314 of updating the cube and storing the change list on the storage medium, respectively. Further, one or more of the acts of method 300 may be repeated after performance of one or more other acts of method 300, for example, in response to events. Method 300 may employ event-based programming and processing techniques, in which various acts are performed in response to a particular event, not necessarily in the sequence shown in method 300.

Method 300 and acts thereof, and various embodiments and variations of the method and these acts, individually or in combination, may be defined by computer-readable signals tangibly embodied on one or more computer-readable media, for example, non-volatile recording media, integrated circuit memory elements, or a combination thereof. Computer readable media can be any available media that can be accessed by a computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can accessed by a computer, and any suitable combination of the foregoing.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, wireless media such as acoustic, RF, infrared and other wireless media, other types of communication media, and any suitable combination of the foregoing.

Computer-readable signals embodied on one or more computer-readable media may define instructions, for example, as part of one or more programs, that, as a result of being executed by a computer, instruct the computer to perform one or more of the functions described herein (e.g., method 300 or any acts thereof), and/or various embodiments, variations and combinations thereof. Such instructions may be written in any of a plurality of programming languages, for example, Java, J#, Visual Basic, C, C#, or C++, Fortran, Pascal, Eiffel, Basic, COBOL, etc., or any of a variety of combinations thereof. The computer-readable media on which such instructions are embodied may reside on one or more of the components of any of systems 100, 200, 400 and 500 described herein, may be distributed across one or more of such components, and may be in transition therebetween.

The computer-readable media may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

It should be appreciated that any single component or collection of multiple components of a computer system, for example, the computer system described in relation to FIGS. 1, 2, 4 and 5, that perform the functions described herein can be generically considered as one or more controllers that control such functions. The one or more controllers can be implemented in numerous ways, such as with dedicated hardware and/or firmware, using a processor that is programmed using microcode or software to perform the functions recited above or any suitable combination of the foregoing.

Various embodiments according to the invention may be implemented on one or more computer systems. These computer systems, may be, for example, general-purpose computers such as those based on Intel PENTIUM-type processor, Motorola PowerPC, Sun UltraSPARC, Hewlett-Packard PA-RISC processors, any of a variety of processors available from Advanced Micro Devices (AMD) or any other type of processor. It should be appreciated that one or more of any type of computer system may be used to implement various embodiments of the invention.

A general-purpose computer system according to one embodiment of the invention is configured to perform one or more of the functions described above. It should be appreciated that the system may perform other functions and the invention is not limited to having any particular function or set of functions.

For example, various aspects of the invention may be implemented as specialized software executing in a general-purpose computer system 400 such as that shown in FIG. 4. The computer system 400 may include a processor 403 connected to one or more memory devices 404, such as a disk drive, memory, or other device for storing data. Memory 404 is typically used for storing programs and data during operation of the computer system 400.

Components of computer system 400 may be coupled by an interconnection mechanism 405, which may include one or more busses (e.g., between components that are integrated within a same machine) and/or a network (e.g., between components that reside on separate discrete machines). The interconnection mechanism 405 enables communications (e.g., data, instructions) to be exchanged between system components of system 400. Computer system 400 also includes one or more input devices 402, for example, a keyboard, mouse, trackball, microphone, touch screen, and one or more output devices 401, for example, a printing device, display screen, speaker. In addition, computer system 400 may contain one or more interfaces (not shown) that connect computer system 400 to a communications network (in addition or as an alternative to the interconnection mechanism 405.

The storage system 406, shown in greater detail in FIG. 5, typically includes a computer readable and writeable nonvolatile recording medium 501 in which signals are stored that define a program to be executed by the processor or information stored on or in the medium 501 to be processed by the program. The medium may, for example, be a disk or flash memory. Typically, in operation, the processor causes data to be read from the nonvolatile recording medium 501 into another memory 502 that allows for faster access to the information by the processor than does the medium 501. This memory 502 is typically a volatile, random access memory such as a dynamic random access memory (DRAM) or static memory (SRAM). It may be located in storage system 406, as shown, or in memory system 404, not shown. The processor 403 generally manipulates the data within the integrated circuit memory 404, 502 and then copies the data to the medium 501 after processing is completed. A variety of mechanisms are known for managing data movement between the medium 501 and the integrated circuit memory element 404, 502, and the invention is not limited thereto. The invention is not limited to a particular memory system 404 or storage system 406.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 400 is shown by way of example as one type of computer system upon which various aspects of the invention may be practiced, it should be appreciated that aspects of the invention are not limited to being implemented on the computer system as shown in FIG. 4. Various aspects of the invention may be practiced on one or more computers having a different architecture or components that that shown in FIG. 4.

Computer system 400 may be a general-purpose computer system that is programmable using a high-level computer programming language. Computer system 400 also may be implemented using specially-programmed, special-purpose hardware. In computer system 400, processor 403 is typically a commercially available processor such as the well-known Pentium class processor available from the Intel Corporation. Many other processors are available. Such a processor usually executes an operating system which may be, for example, the Windows® 95, Windows® 98, Windows NT®, Windows® 2000 (Windows® ME) or Windows® XP operating systems available from the Microsoft Corporation, MAC OS System X available from Apple Computer, the Solaris Operating System available from Sun Microsystems, Linux available from various sources or UNIX available from various sources. Any of a variety of other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system, and that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communications network (e.g., the Internet) using a communication protocol (e.g., TCP/IP).

It should be appreciated that the invention is not limited to executing on any particular system or group of systems, and that the invention is not limited to any particular distributed architecture, network, or communication protocol.

Various embodiments of the present invention may be programmed using an object-oriented programming language, such as SmallTalk, Java, J# (J-Sharp), C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions).

Various aspects of the invention may be implemented as programmed or non-programmed elements, or any combination thereof. Further, various embodiments of the invention may be implemented using Microsoft® NET technology available from Microsoft Corporation. Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any equivalent means, known now or later developed, for performing the recited function.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A system, on a user device of a communications network, for using at least a portion of a multi-dimensional database stored on a network device that is a separate device from the user device on the communications network, the multi-dimensional database shared by a plurality of user devices on the communications network, the system comprising:
a storage controller to control storing a copy of the at least portion of the multi-dimensional database on a non-volatile storage medium on the user device; and
a query controller to receive a request from an application executing on the user device for a piece of information included in the at least portion of the multi-dimensional database, and to control retrieving the piece of information from the copy on the non-volatile storage medium.

2. The system of claim 1, wherein the at least portion of the multi-dimensional database includes at least a first piece of information that is a function of at least a second piece of information included in the at least portion, and
wherein the storage controller is operative to control storing the function within the copy on the non-volatile storage medium, the system further comprising:
a function controller to perform the function on the first piece of information in the volatile memory in response to the application changing a value of the second piece of information in a volatile memory on the user device.

3. The system of claim 2, wherein the function controller is operative to communicate a result of the performance of the function to a user interface display of the application, so that a value of the first piece of information resulting from the performance of the function can be displayed.

4. The system of claim 2, wherein the change is one of a plurality of changes made in the volatile memory to one or more pieces of information included in the copy of the at least portion of the multi-dimensional database, the system further comprising:
a change list controller to control adding the change to a change list representing the plurality of changes, the change list resident in the volatile memory.

5. The system of claim 4, wherein the storage controller is operative to control updating the copy of the at least portion of the multi-dimensional database on the non-volatile storage medium by applying the change list from the volatile memory.

6. The system of claim 4, wherein the storage controller is operative to control storing the change list on the non-volatile storage medium.

7. The system of claim 4, further comprising:
a server interface controller to control transmitting the change list from the user device to the network device.

8. The system of claim 1, further comprising:
a server interface controller operative to receive at least one communication from the network device indicating one or more changes to the at least portion of the multi-dimensional database, and to control synchronizing the local copy of the at least portion of the multi-dimensional database with the at least portion of the multi-dimensional database in response to the at least one communication.

9. A method of using at least a portion of a multi-dimensional database residing on a network device of a communications network, the multi-dimensional database shared by a plurality of user devices on the communications network and including at least a first piece of information that is a function of at least a second piece of information included in the at least portion, the method comprising acts of:
(A) storing a copy of the at least portion of the multi-dimensional database on a non-volatile storage medium of a user device that is a separate device from the network device on the communications network, including storing the function within the copy on the non-volatile storage medium; and
(B) in response to the application changing a value of the second piece of information in a volatile memory on the user device, performing the function on the first piece of information in the volatile memory.

10. The method of claim 9, wherein the change is one of a plurality of changes made in the volatile memory to one or more pieces of information included in the copy of the at least portion of the multi-dimensional database, the method further comprising an act of:
(E) adding the change to a change list representing the plurality of changes, the change list resident in the volatile memory.

11. The method of claim 10, further comprising an act of:
(F) updating the copy of the at least portion of the multi-dimensional database on the non-volatile storage medium by applying the change list from the volatile memory.

12. The method of claim 10, further comprising an act of:
(F) storing the change list on the non-volatile storage medium.

13. The method of claim 10, further comprising an act of:
(F) transmitting the change list from the user device to the network device.

14. The method of claim 9, further comprising an act of:
(G) generating a report from the copy of the at least portion of the multi-dimensional database.

15. The method of claim 9 further comprising:
(C) receiving at least one communication from the network device indicating one or more changes to the at least portion of the multi-dimensional database; and
(D) synchronizing the local copy of the at least portion of the multi-dimensional database with the at least portion of the multi-dimensional database in response to the at least one communication.

16. A computer program product comprising:
a computer-readable medium; and
computer-readable signals, stored on the computer-readable medium, that define instructions that, as a result of being executed by a computer, control the computer to perform a process of using at least a portion of a multi-dimensional database residing on a network device of a communications network, the multi-dimensional database shared by a plurality of user devices on the communications network, the process comprising acts of:
(A) transmitting a request, to the network device from a user device that is a separate device from the network device on the communications network, for a copy of at least a portion of the multi-dimensional database;
(B) receiving at the user device a copy of the at least portion of the multi-dimensional database; and
(C) storing the copy of the at least portion of the multi-dimensional database on a non-volatile storage medium of the user device.

17. The computer-readable medium of claim 16, the method further comprising an act of:
(D) in response to a request from an application executing on the user device for a piece of information included in the at least portion of the multi-dimensional database, retrieving the piece of information from the copy on the non-volatile storage medium.

18. The computer-readable medium of claim 16, wherein the at least portion of the multi-dimensional database includes at least a first piece of information that is a function of at least a second piece of information included in the at least portion, and
wherein the act (A) comprises storing the function within the copy on the non-volatile storage medium, the computer-readable medium further comprising an act of:
(C) in response to the application changing a value of the second piece of information in a volatile memory on the user device, performing the function on the first piece of information in the volatile memory.

19. The computer-readable medium of claim 18, wherein the change is one of a plurality of changes made in the volatile memory to one or more pieces of information included in the copy of the at least portion of the multi-dimensional database, wherein the process further comprising an act of:
(E) adding the change to a change list representing the plurality of changes, the change list resident in the volatile memory.

20. The computer-readable medium of claim 19, wherein the process further comprises an act of:
(F) transmitting the change list from the user device to the network device.
